(19) United States
(12) Patent Application Publication
(10) Pub. No.: US 2013/0177270 A1
(43) Pub. Date: Jul. 11, 2013

(54) BEARING OF A SHAFT, IN PARTICULAR A MASS BALANCING SHAFT, WITH THE AID OF ROLLER BEARINGS

(71) Applicant: Patrick Ullman, Herzogenaurach (DE)

(72) Inventor: Patrick Ullman, Herzogenaurach (DE)

(73) Assignee: Schaeffler Technologies AG & Co.KG, Herzogenaurach (DE)

(21) Appl. No.: 13/822,486

(22) PCT Filed: Jul. 6, 2011
(86) PCT No.: PCT/EP11/61358

§ 371 Date: Mar. 12, 2013

(30) Foreign Application Priority Data
Sep. 17, 2010 (DE) 102010045875.9

(51) Int. Cl. F16C 33/46

(52) U.S. Cl. CPC F16C 33/4694
USPC 384/576; 384/572

(57) ABSTRACT

A bearing system having a shaft which has at least one bearing journal, a needle bearing having a cage (2) and needle rollers (3) accommodated therein being mountable on the bearing journal, and having an outer ring (1) which is inserted into a machine housing. According to the invention, the cage (2), at least on one side axially next to the needle rollers (3), has a mounting bevel (8) or beveled elements, the radial extension of which decreases with increasing distance from the needle rollers (3).

The present invention relates to a bearing system having a shaft which has at least one bearing journal, a needle bearing having a cage and needle rollers accommodated therein being mountable on the bearing journal, and having an outer ring which is inserted into a machine housing.

### BACKGROUND

German Patent application 10 2009 031 064.9 which is not necessarily prior art to the present invention discloses the track of the bearing journal in a generic bearing system with undercuts, and to design the axial distance between the axial shoulders with a particular width.

### SUMMARY OF THE INVENTION

However, beyond the category-defining features, this document provides no further suggestions concerning simplifying the installation of the shaft in the machine housing. Namely, the problem arises that after installation of the cage on the bearing journal, the cage drops downwardly and the needle rollers shift in the cage due to the play of the needle rollers in the cage when the shaft is horizontally installed in the machine housing, so that the concentricity between the shaft and the cage is no longer provided. As a result, insertion of the shaft into the machine housing, in particular insertion of the cage and the needle rollers into the outer rings which are already installed in the machine housing, is difficult or impossible.

It is an object of the present invention to eliminate the above-described disadvantages of the known design and to simplify installation in a simple and cost-effective manner.

The present invention provides that the cage, at least on one side axially next to the needle rollers, has a mounting bevel or beveled elements, the radial extension of which decreases with increasing distance from the needle rollers. This results in an approximately conical ramp at the cage, so that when the shaft is inserted into the outer rings, the cage together with the needle rollers is lifted, and the concentricity between the outer ring and the cage is established.

In order to also compensate for the play of the needle rollers in the cage, in particular in the lower area of the bearing journal, in another embodiment of the present invention it is proposed that the outer ring, at least on one side facing the installation direction, has a bevel which expands toward the edge of the outer ring. The remaining eccentricity of the needle rollers with respect to the inner surface of the outer ring may thus be easily compensated for, so that there are no obstacles or difficulties in pushing the shaft together with the cage and needle rollers into the outer ring, and thus, in carrying out the final installation.

In addition, the cage may have a lipped outer race and empty pockets, at least on one side, and the lipped outer race and/or the webs between the empty pockets may be designed as a mounting bevel or beveled elements. This results in a longer mounting bevel and thus a smaller pitch, thus further simplifying installation.

The cage advantageously may be made of a plastic material and may have has a radially expandable design, so that it is easy to install the cage together with the needle rollers, even if the bearing journal is radially recessed with respect to adjacent shaft sections, at least over part of the periphery.

The expandability may be simplified in that the cage has a separation slit oriented parallel to the axes of the needle rollers, the ends of the cage having fastening elements which fit together. After the cage is placed on the bearing journal, the ends may be connected to one another, for example fastened together with the aid of hooks. However, other fastening elements such as a lock or clips may be provided.

### BRIEF DESCRIPTION OF THE DRAWINGS

One preferred specific embodiment of the bearing designed according to the present invention is explained in greater detail below with reference to the appended drawings.

FIG. 1 shows a perspective view of a bearing having an outer ring, needle rollers, and a cage which is partially inserted into the outer ring;

FIG. 2 shows a sectional view of an outer ring and a cage together with needle rollers at the start of installation;

FIG. 3 shows a perspective view of a bearing similar to that in FIG. 1; and

FIG. 4 shows a sectional view of a bearing in the installed position.

### DETAILED DESCRIPTION

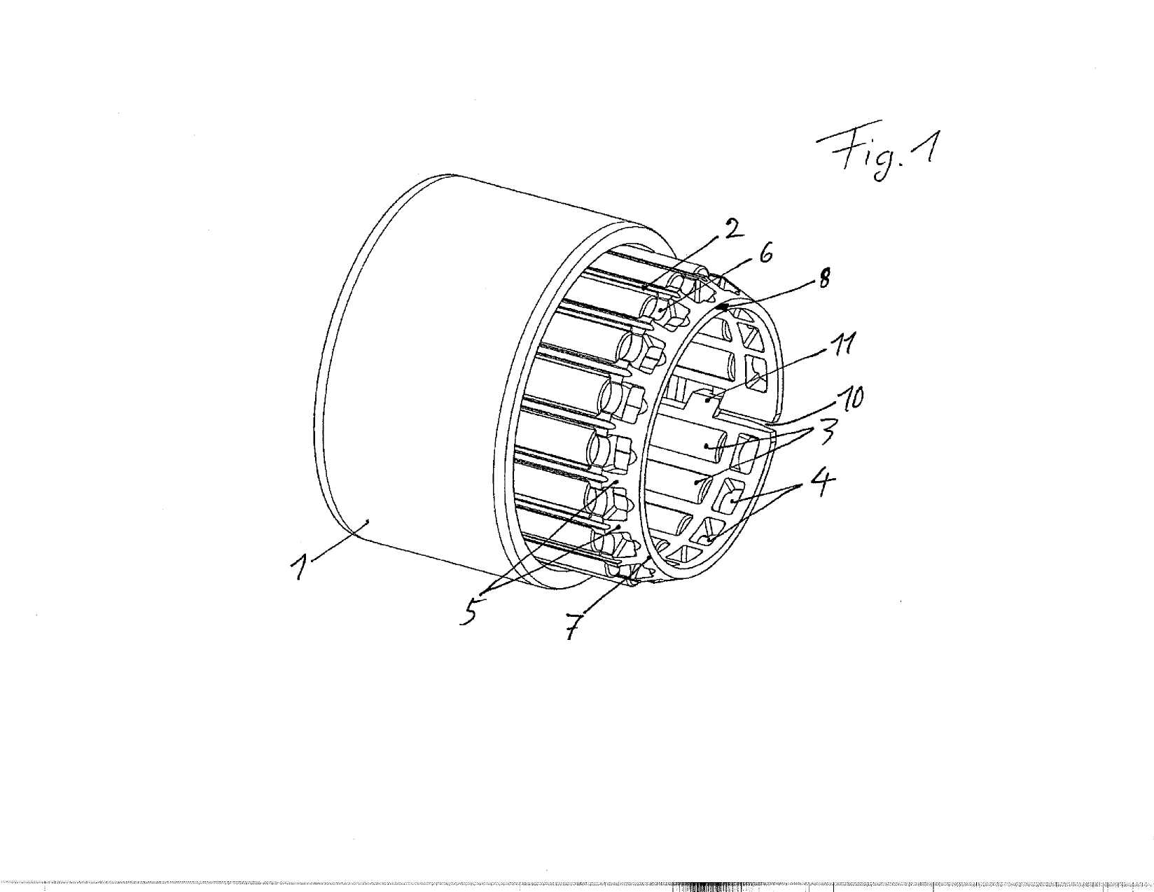

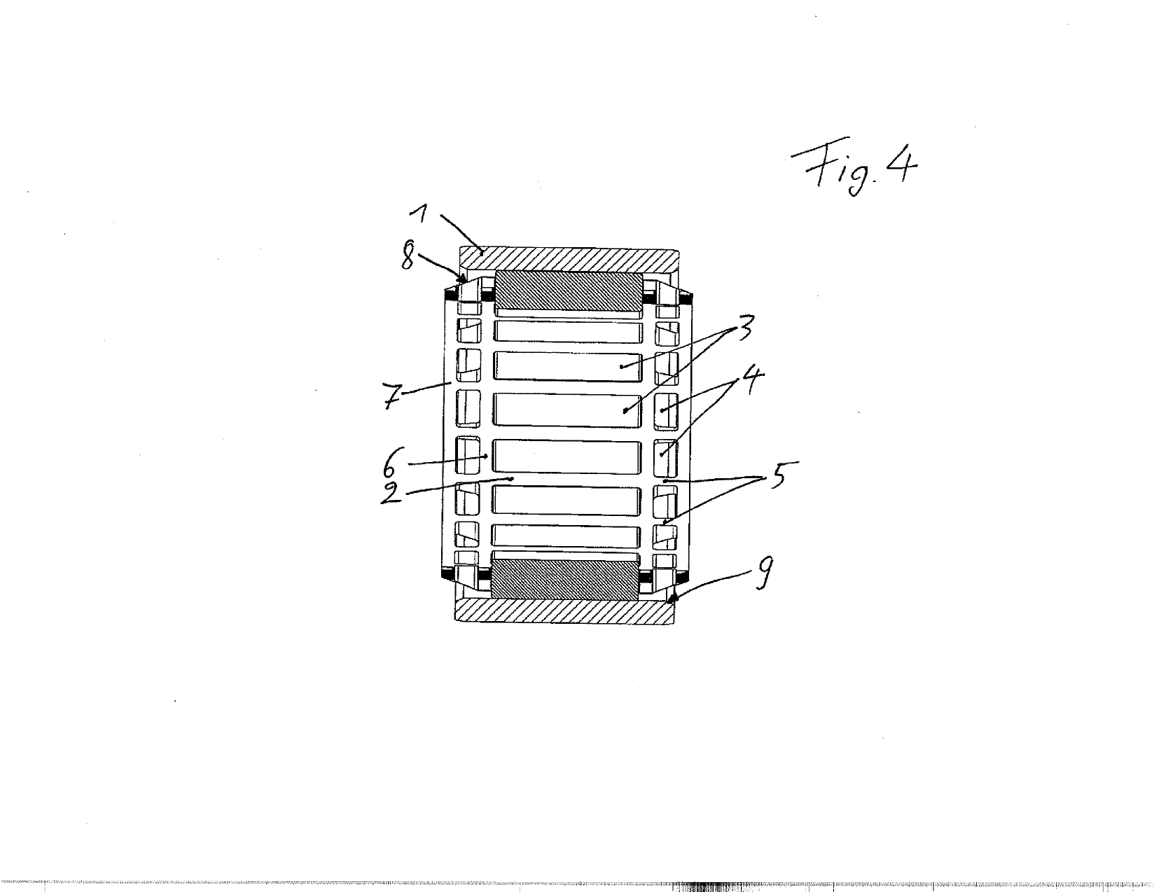

FIGS. 1 through 4 show an outer ring of a roller bearing, denoted by reference numeral 1, in which a cage 2 having recesses for needle rollers 3 is insertable. In addition to the recesses for needle rollers 3, cage 2 has empty pockets 4 which are separated by webs 5, webs 5 extending from a lipped inner race 6 to a lipped outer race 7 and connecting same to one another. A mounting bevel 8 is mounted on both sides of cage 2, starting from lipped inner race 6, via webs 5, to lipped outer race 7, and tapers conically from lipped inner race 6 to lipped outer race 7. The lipped inner race may also be included in mounting bevel 8, so that the bevel begins next to needle rollers 3.

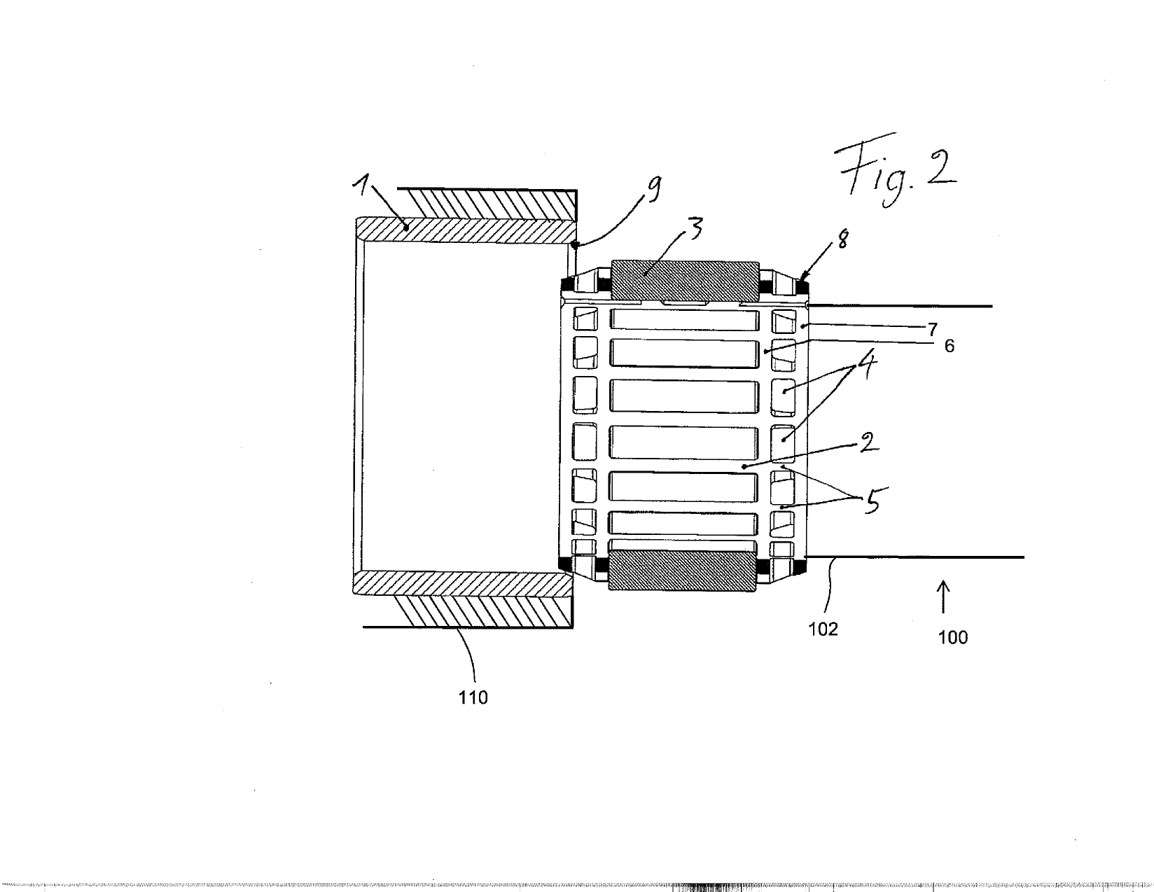

As is apparent in particular from FIG. 2, during horizontal installation of the shaft 100, shown schematically, in the machine housing 110, shown schematically, cage 2 is lifted through outer ring 1 via mounting bevel 8, resulting in centering of cage 2 and essentially also of needle rollers 3 in outer ring 1.

To also further simplify the centering of needle rollers 3 in outer ring 1, outer ring 1 has an outwardly expanding bevel 9, so that when cage 2 is further inserted into outer ring 1 according to FIG. 2, needle rollers 3, which are also lowered somewhat due to the play of needle rollers 3 in cage 2, are further raised and inserted into outer ring 1.

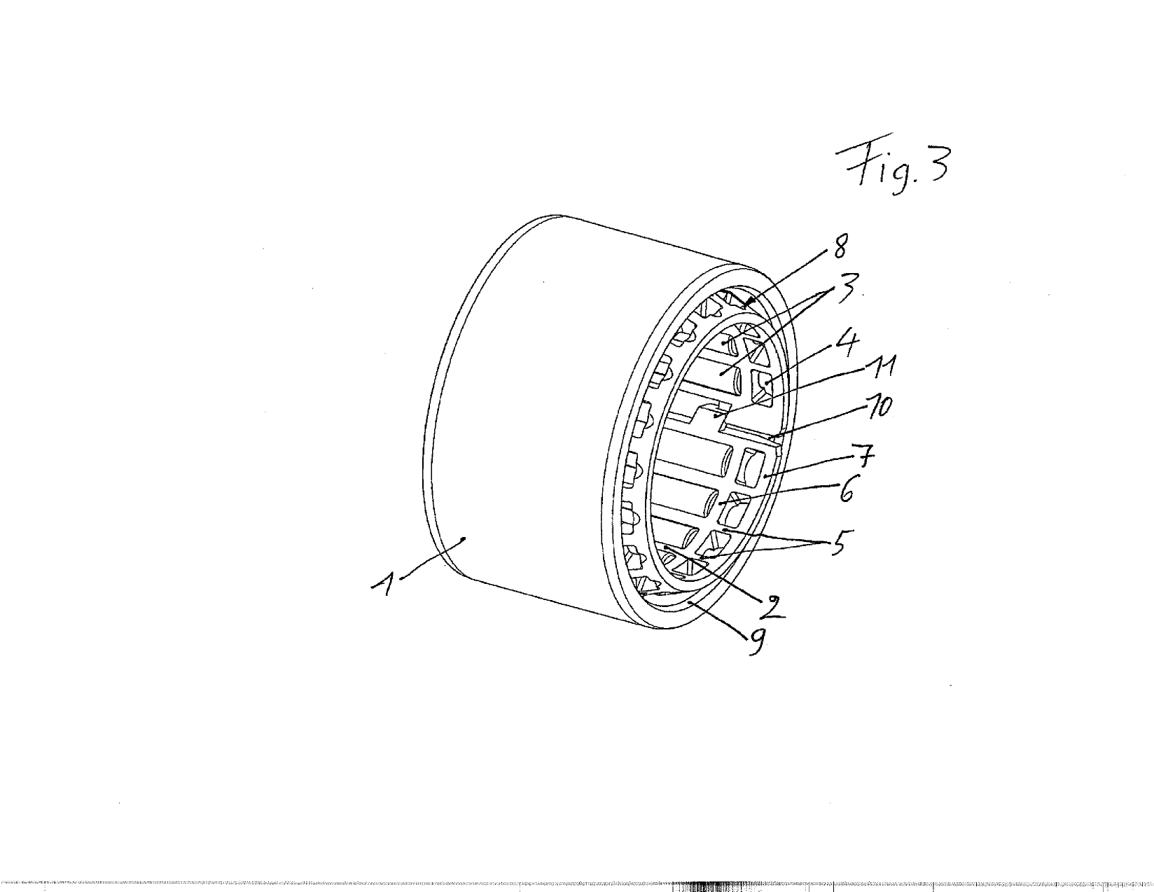

As visible in FIGS. 1 and 3, cage 2 has a separation slit 10, as the result of which the cage, made of a plastic material, may be easily expanded and pushed over adjacent shaft sections of a larger radial extension, or may also be radially pushed directly onto a bearing journal 102, shown schematically, of a mass balancing shaft. After enclosing the bearing journal, the ends of cage 2 may be fastened together with the aid of fastening elements 11, apparent in FIGS. 1 and 3, to ensure a precisely fitting enclosure of cage 2 around the bearing journal.

### List of Reference Numerals

1 Outer Ring

2 Cage

3 Needle Rollers

4 Empty Pockets

5 Webs

6 Lipped inner Race

7 Lipped Outer Race

8 Mounting Bevel

9 Bevel

10 Separation Slit

11 Fastening Elements

100 Shaft

102 Bearing Journal

110 Machine Housing

1 to 5. (canceled)

6. A bearing system comprising:
a shaft having at least one bearing journal;
a needle bearing including a cage and needle rollers accommodated in the cage, the needle bearing being mountable on the bearing journal, and having an outer ring inserted into a machine housing,
the cage, at least on one side axially next to the needle rollers, having a mounting bevel or beveled elements, a radial extension of the mounting bevel or beveled elements decreasing with increasing distance from the needle rollers.

7. The bearing system as recited in claim 6 wherein the outer ring, at least on one side, has an outer ring bevel expanding toward an edge of the outer ring.

8. The bearing system as recited in claim 6 wherein the cage has a lipped outer race, webs defining empty pockets, and a lipped inner race, at least on one side, the lipped outer race and/or the webs between the empty pockets and/or the lipped inner race are designed as the mounting bevel or the beveled elements.

9. The bearing system as recited in claim 6 wherein the cage is made of a plastic material and has a radially expandable design.

10. The bearing system as recited in claim 6 wherein the cage has a separation slit oriented parallel to the axes of the needle rollers, ends of the cage having fastening elements fitting together.
